(19) United States
(12) Patent Application Publication
(10) Pub. No.: US 2016/0087274 A1
(43) Pub. Date: Mar. 24, 2016

(54) ANODE ACTIVE MATERIAL, SODIUM ION BATTERY AND LITHIUM ION BATTERY

(71) Applicant: TOYOTA JIDOSHA KABUSHIKI KAISHA, Toyota-shi (JP)

(72) Inventor: Hideki NAKAYAMA, Susono-shi (JP)

(21) Appl. No.: 14/845,052

(22) Filed: Sep. 3, 2015

(30) Foreign Application Priority Data
Sep. 19, 2014 (JP) 2014-191087

(51) Int. Cl. H01M 4/485; H01M 10/054; H01M 10/0525

(52) U.S. Cl. CPC H01M 4/485; H01M 10/0525; H01M 10/054

(57) ABSTRACT

The present invention aims to provide an anode active material which may intend to improve safety of a battery. The object is attained by providing an anode active material used for a sodium ion battery or a lithium ion battery, wherein the anode active material has an A′Aₖ₋₁BₖO₃ₖ₊₁ phase (A′ is at least one kind of K and Na, A is at least one kind of La, Ce, Pr, Nd, Sm, Eu, Gd, Ca and Sr, B is Nb, and k is 2, 3 or 4) as a Dion-Jacobson type crystal phase.

### TECHNICAL FIELD

The present invention relates to an anode active material which may intend to improve safety of a battery.

### BACKGROUND ART

A lithium ion battery is a battery such that an Li ion moves between a cathode and an anode. The lithium ion battery has the advantage that energy density is high. In contrast, a sodium ion battery is a battery such that an Na ion moves between a cathode and an anode. Na exists so abundantly as compared with Li that the sodium ion battery has the advantage that lower costs are easily intended as compared with the lithium ion battery. Generally, these batteries have a cathode active material layer containing a cathode active material, an anode active material layer containing an anode active material, and an electrolyte layer formed between the cathode active material layer and the anode active material layer.

It is known that a carbon material is used as an anode active material used for these batteries. For example, in Patent Literature 1, a nonaqueous electrolyte secondary battery is disclosed, in which lithium ferric phosphate represented by LiₓFePO₄ is used as a cathode active material and a carbon material such that average action potential is 0.3 V or less on the basis of lithium is used as an anode active material.

Incidentally, in Non Patent Literature 1, it is described that Li is electrochemically inserted into and desorbed from LiCa₂Nb₃O₁₀ and LiLaNb₂O₇ as a superconducting material.

### CITATION LIST

### Patent Literature

Patent Literature 1: Japanese Patent Application (JP-A) No. 2010-231958

### Non Patent Literature

Non Patent Literature 1: R. Jones et al., “Lithium insertion into the layered perovskites LiCa₂Nb₃O₁₀ and LiLaNb₂O₇”, Solid State Ionics 45 (1991) 173-179

### SUMMARY OF INVENTION

### Technical Problem

For example, with regard to the carbon material described in Patent Literature 1, average action potential is 0.3 V or less on the basis of lithium, so that the problem is that metal Li is easily precipitated. Also, examples of an anode material useful for a sodium ion battery include hard carbon, which is around 0 V in average action potential, so that the problem is that metal Na is easily precipitated. Thus, action potential of an anode active material is so low that metal is easily precipitated on the surface of the anode active material, so that the problem is that it is difficult to secure the safety of a battery.

The present invention has been made in view of the above circumstances, and a main object thereof is to provide an anode active material which can improve the safety of a battery.

### Solution to Problem

In order to achieve the object described above, the present invention provides an anode active material used for a sodium ion battery or a lithium ion battery, wherein the anode active material has an A′Aₖ₋₁BₖO₃ₖ₊₁ phase (A′ is at least one kind of K and Na, A is at least one kind of La, Ce, Pr, Nd, Sm, Eu, Gd, Ca and Sr, B is Nb, and k is 2, 3 or 4) as a Dion-Jacobson type crystal phase.

According to the present invention, the A′Aₖ₋₁BₖO₃ₖ₊₁ phase acts at comparatively high electric potential, so that an improvement in safety of the battery may be intended.

In the invention described above, the A is preferably at least one kind of La and Ca.

In the invention described above, a part of the A may be substituted with Na.

The present invention also provides a sodium ion battery comprising a cathode active material layer containing a cathode active material, an anode active material layer containing an anode active material, and an electrolyte layer formed between the cathode active material layer and the anode active material layer, wherein the anode active material is the anode active material described above.

According to the present invention, the use of the anode active material described above allows the sodium ion battery with high safety.

The present invention further provides a lithium ion battery comprising a cathode active material layer containing a cathode active material, an anode active material layer containing an anode active material, and an electrolyte layer formed between the cathode active material layer and the anode active material layer, wherein the anode active material is the anode active material described above.

According to the present invention, the use of the anode active material described above allows the lithium ion battery with high safety.

### Advantageous Effects of Invention

An anode active material of the present invention produces the effect to improve the safety of the battery.

### BRIEF DESCRIPTION OF DRAWINGS

FIG. 1 is a schematic cross-sectional view showing an example of a sodium ion battery or a lithium ion battery of the present invention.

FIGS. 2A to 2E are results of measuring XRD of active materials each obtained in Examples 1 to 5.

FIG. 3 is a schematic view showing a crystal structure of a KLaNb₂O₇ phase.

FIGS. 4A to 4E are results of charge and discharge tests of evaluation batteries (sodium ion batteries) using active materials each obtained in Examples 1 to 5.

FIGS. 5A to 5E are results of charge and discharge tests of evaluation batteries (lithium ion batteries) using active materials each obtained in Examples 1 to 5.

### DESCRIPTION OF EMBODIMENTS

An anode active material, a sodium ion battery and a lithium ion battery of the present invention are hereinafter described in detail.

A. Anode Active Material

The anode active material of the present invention is an anode active material used for a sodium ion battery or a lithium ion battery, wherein the anode active material has an A′Aₖ₋₁BₖO₃ₖ₊₁ phase (A′ is at least one kind of K and Na, A is at least one kind of La, Ce, Pr, Nd, Sm, Eu, Gd, Ca and Sr, B is Nb, and k is 2, 3 or 4) as a Dion-Jacobson type crystal phase.

According to the present invention, the A′Aₖ₋₁BₖO₃ₖ₊₁ phase acts at comparatively high electric potential, so that an improvement in safety of the battery may be intended. In particular, in the case where action potential of the anode active material having an A′Aₖ₋₁BₖO₃ₖ₊₁ phase is in the vicinity of 1 V, the action potential in the vicinity of 1 V is such a moderate electric potential as the anode active material as to have the advantage that battery voltage may be increased while restraining metal Na or metal Li from precipitating. Also, the anode active material of the present invention has the advantage that heat resistance is favorable by reason of being ordinarily an oxide active material.

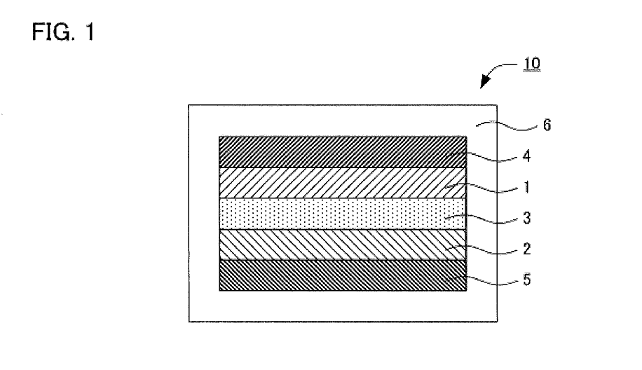

Meanwhile, in Non Patent Literature 1, it is described that Li is electrochemically inserted into and desorbed from LiCa₂Nb₃O₁₀ and LiLaNb₂O₇ as a superconducting material. However, in Non Patent Literature 1, as shown in FIGS. 1 and 8, an insertion desorption reaction of Li ions is caused in a range of 1.8 V or more (vs Li/Li⁺). In the case of being considered as use for a battery, this electric potential is an electric potential assumed for application as a cathode active material and is not an electric potential assumed for application as an anode active material. Also, in Non Patent Literature 1, insertion and desorption of Na ions are not described or suggested. In recent years, research and development of a sodium ion battery have been actively conducted, and various materials have been proposed for a cathode active material; however, hard carbon has been reported at most for an anode active material. In the present invention, it has been first found out that the active material having an A′Aₖ₋₁BₖO₃ₖ₊₁ phase is useful as the anode active material for a sodium ion battery or a lithium ion battery.

The anode active material of the present invention has an A′Aₖ₋₁BₖO₃ₖ₊₁ phase as a Dion-Jacobson type crystal phase. Generally, examples of a perovskite-related oxide include a perovskite oxide and a layered perovskite oxide. A Dion-Jacobson type oxide is a compound belonging to a layered perovskite oxide together with a Ruddlesden-Popper type oxide and an Aurivillius type oxide. The Dion-Jacobson type oxide has a layer structure in which an A′ layer and an Aₖ₋₁BₖO₃ₖ₊₁ layer (a perovskite layer) are laminated to each other.

A′ in the A′Aₖ₋₁BₖO₃ₖ₊₁ phase is ordinarily at least one kind of K and Na. Also, A in the A′Aₖ₋₁BₖO₃ₖ₊₁ phase is ordinarily at least one kind of La, Ce, Pr, Nd, Sm, Eu, Gd, Ca and Sr. As described in the Examples hereinafter, it is confirmed that the case where A is La offers a desired effect. Thus, a similar effect may be expected also in lanthanoid elements (Ce, Pr, Nd, Sm, Eu and Gd) having the same ionic radius and chemical properties as La. Also, in the Examples hereinafter, it is confirmed that the case where A is La and the case where A is Ca offer a desired effect. The ionic radius of La³⁺ is 115 pm and the ionic radius of Ca²⁺ is 99 pm, so that a similar effect may be expected also in Sr having an ionic radius therebetween (Sr²⁺=113 pm). In addition, B in the A′Aₖ₋₁BₖO₃ₖ₊₁ phase is ordinarily Nb, and “k” in the A′Aₖ₋₁BₖO₃ₖ₊₁ phase is ordinarily 2, 3 or 4.

Also, the presence of the A′Aₖ₋₁BₖO₃ₖ₊₁ phase may be confirmed by X-ray diffraction (XRD) measurement. Typical examples of the case of k=2 include a KLaNb₂O₇ phase. With regard to the KLaNb₂O₇ phase, in X-ray diffraction measurement using a CuKα ray, typical peaks ordinarily appear in 2θ=8.35°, 9.09°, 23.49°, 24.01°, 24.86°, 25.02°, 26.40°, 27.56°, 31.48° and 33.89°. Typical examples of the case of k=3 include a KCa₂Nb₃O₁₀ phase. With regard to the KCa₂Nb₃O₁₀ phase, in X-ray diffraction measurement using a CuKα ray, typical peaks ordinarily appear in 2θ=5.84°, 11.68°, 18.10°, 23.10°, 24.10°, 27.50°, 29.40°, 31.30°, 32.90° and 46.80°. Typical examples of the case of k=4 include a Na[NaCa₂]Nb₄O₁₃ phase. With regard to the Na[NaCa₂]Nb₄O₁₃, in X-ray diffraction measurement using a CuKα ray, typical peaks ordinarily appear in 2θ=4.90°, 9.80°, 14.70°, 19.60°, 23.00°, 24.10°, 24.60°, 26.00°, 28.70°, 32.10° and 46.80°. The anode active material of the present invention preferably has the peak described above. Incidentally, a peak position in XRD occasionally shifts in accordance with constituent elements, so that the peak position may be within a range of ±2.00° or within a range of ±1.00°. The crystal system of the Aₖ₋₁BₖO₃ₖ₊₁ phase is preferably an orthorhombic crystal.

The anode active material of the present invention is preferably large in the ratio of the A′Aₖ₋₁BₖO₃ₖ₊₁ phase; specifically, the anode active material preferably contains the A′Aₖ₋₁BₖO₃ₖ₊₁ phase mainly. Here, ‘containing the A′Aₖ₋₁BₖO₃ₖ₊₁ phase mainly’ signifies that the ratio of the A′Aₖ₋₁BₖO₃ₖ₊₁ phase is the largest in all crystal phases contained in the anode active material. The ratio of the A′Aₖ₋₁BₖO₃ₖ₊₁ phase contained in the anode active material is preferably 50 mol % or more, more preferably 60 mol % or more, and far more preferably 70 mol % or more. The anode active material of the present invention may be such as to include only the A′Aₖ₋₁BₖO₃ₖ₊₁ phase (a single-phase active material). Incidentally, the ratio of the A′Aₖ₋₁BₖO₃ₖ₊₁ phase contained in the anode active material may be determined by a quantitative analysis method through X-ray diffraction (such as a quantification method by R-value and a Rietveld method).

The anode active material of the present invention contains an A′ element, an A element, a B element and an O element, and has the A′Aₖ₋₁BₖO₃ₖ₊₁ phase described above. The composition of the anode active material of the present invention is not particularly limited if the composition has the Dion-Jacobson type crystal phase described above. In the case of k=2, the anode active material of the present invention preferably has a composition of A′AB₂O₇ and the proximity thereof. Specifically, the anode active material preferably has a composition of A′ₓA_{y}B_{z}O_{w} (0.5≦x≦1.5, 0.5≦y≦1.5, 1.5≦z≦2.5, 6.5≦w≦7.5). Also, in the case of k=3, the anode active material of the present invention preferably has a composition of A′A₂B₃O₁₀ and the proximity thereof. Specifically, the anode active material preferably has a composition of A′ₓA_{y}B_{z}O_{w} (0.5≦x≦1.5, 1.5≦y≦2.5, 2.5≦z≦3.5, 9.5≦w≦10.5). Also, in the case of k=4, the anode active material of the present invention preferably has a composition of A′A₃B₄O₁₃ and the proximity thereof. Specifically, the anode active material preferably has a composition of A′ₓA_{y}B_{z}O_{w} (0.5≦x≦1.5, 2.5≦y≦3.5, 3.5≦z≦4.5, 12.5≦w≦13.5).

The shape of the anode active material of the present invention is preferably a particulate shape, for example. Also, the average particle diameter thereof (D₅₀) is preferably, for example, from 1 nm to 100 μm, above all, from 10 nm to 30 pm.

A method for producing the anode active material of the present invention is not particularly limited as long as the method allows the active material described above, but examples thereof include an ion exchange method, a flux method, a sol-gel method, a spray-drying method, an atomized pyrolysis method, a hydrothermal method, and a coprecipitation method.

B. Sodium Ion Battery

FIG. 1 is a schematic cross-sectional view showing an example of a sodium ion battery of the present invention. A sodium ion battery 10 shown in FIG. 1 comprises a cathode active material layer 1, an anode active material layer 2, an electrolyte layer 3 formed between the cathode active material layer 1 and the anode active material layer 2, a cathode current collector 4 for collecting the cathode active material layer 1, an anode current collector 5 for collecting the anode active material layer 2, and a battery case 6 for storing these members. The anode active material layer 2 contains the anode active material described in the “A. Anode active material”.

According to the present invention, the use of the anode active material described above allows the sodium ion battery with high safety.

The sodium ion battery of the present invention is hereinafter described in each constitution.

1. Anode Active Material Layer

The anode active material layer in the present invention is a layer containing at least the anode active material. The anode active material layer may contain at least one of a conductive material, a binder and a solid electrolyte material in addition to the anode active material.

The anode active material in the present invention is ordinarily the anode active material described in the “A. Anode active material”. The content of the anode active material is preferably larger from the viewpoint of capacity; preferably, for example, from 60% by weight to 99% by weight, above all, from 70% by weight to 95% by weight.

Examples of the conductive material include a carbon material. Specific examples of the carbon material include acetylene black, Ketjen Black, VGCF and graphite. The content of the conductive material is preferably, for example, from 5% by weight to 80% by weight, above all, from 10% by weight to 40% by weight.

Examples of the binder include polyvinylidene difluoride (PVDF), polyimide (PI), carboxymethyl cellulose (CMC) and styrene-butadiene rubber (SBR). The content of the binder is preferably, for example, from 1% by weight to 40% by weight.

The solid electrolyte material is not particularly limited as long as the material has desired ion conductivity, but examples thereof include an oxide solid electrolyte material and a sulfide solid electrolyte material. The content of the solid electrolyte material is preferably, for example, from 1% by weight to 40% by weight.

The thickness of the anode active material layer varies greatly with the constitution of the battery, and is preferably from 0.1 μm to 1000 μm, for example.

2. Cathode Active Material Layer

The cathode active material layer in the present invention is a layer containing at least the cathode active material. The cathode active material layer may contain at least one of a conductive material, a binder and a solid electrolyte material in addition to the cathode active material.

Examples of the cathode active material include bed type active materials, spinel type active materials, and olivine type active materials. Examples of the cathode active material include an oxide active material, Specific examples of the cathode active material include NaFeO₂, NaNiO₂, NaCoO₂, NaMnO₂, NaVO₂, Na(NiₓMn₁₋ₓ)O₂ (0<X<1), Na(FeₓMn₁₋ₓ)O₂ (0<X<1), NaVPO₄F, Na₂FePO₄F, Na₃V₂(PO₄)₃, and Na₄M₃ (PO₄)₂P₂O₇ (M is at least one kind of Co, Ni, Fe and Mn).

The kinds and content of the conductive material, the binder and the solid electrolyte material used for the cathode active material layer are the same as the contents described in the anode active material layer described above; therefore, the description herein is omitted. The thickness of the cathode active material layer varies greatly with the constitution of the battery, and is preferably from 0.1 μm to 1000 μm, for example.

3. Electrolyte Layer

The electrolyte layer in the present invention is a layer formed between the cathode active material layer and the anode active material layer. Ion conduction between the cathode active material and the anode active material is performed through the electrolyte contained in the electrolyte layer. The form of the electrolyte layer is not particularly limited but examples thereof include a liquid electrolyte layer, a gel electrolyte layer and a solid electrolyte layer.

The liquid electrolyte layer is ordinarily a layer obtained by using a nonaqueous liquid electrolyte. The nonaqueous liquid electrolyte ordinarily contains a sodium salt and a nonaqueous solvent. Examples of the sodium salt include inorganic sodium salts such as NaPF₆, NaBF₄, NaClO₄ and NaAsF₆; and organic sodium salts such as NaCF₃SO₃, NaN(CF₃SO₂)₂, NaN(C₂F₅SO₂)₂, NaN(FSO₂)₂ and NaC(CF₃SO₂)₃.

The nonaqueous solvent is not particularly limited as long as the solvent dissolves the sodium salt. Examples of the high-dielectric-constant solvent include cyclic ester (cyclic carbonate) such as ethylene carbonate (EC), propylene carbonate (PC) and butylene carbonate (BC), γ-butyrolactone, sulfolane, N-methylpyrrolidone (NMP), and 1,3-dimethyl-2-imidazolidinone (DMI). Meanwhile, examples of the low-viscosity solvent include chain ester (chain carbonate) such as dimethyl carbonate (DMC), diethyl carbonate (DEC) and ethyl methyl carbonate (EMC), acetates such as methyl acetate and ethyl acetate, and ether such as 2-methyltetrahydrofuran. A mixed solvent such that the high-dielectric-constant solvent and the low-viscosity solvent are mixed may be used.

The concentration of the sodium salt in the nonaqueous liquid electrolyte is, for example, from 0.3 mol/L to 5 mol/L, preferably from 0.8 mol/L to 1.5 mol/L. The thickness of the electrolyte layer varies greatly with kinds of the electrolyte and constitutions of the battery, and is preferably, for example from 0.1 μm to 1000 μm.

4. Other Constitutions

The sodium ion battery of the present invention ordinarily comprises a cathode current collector for collecting the cathode active material layer and an anode current collector for collecting the anode active material layer. Examples of a material for the cathode current collector include SUS, aluminum, nickel, iron, titanium and carbon. Meanwhile, examples of a material for the anode current collector include SUS, copper, nickel and carbon. Examples of the shape of the current collectors include a foil shape, a mesh shape and a porous shape. In addition, examples of a method for forming the active material layers on the current collectors include a doctor blade method, an electrostatic coating method, a dip coat method and a spray coat method.

The sodium ion battery of the present invention may include a separator between the cathode active material layer and the anode active material layer. A material for the separator may be an organic material or an inorganic material. Specific examples thereof include porous membranes such as polyethylene (PE), polypropylene (PP), cellulose and polyvinylidene fluoride. The separator may be a single-layer structure (such as PE and PP) or a laminated structure (such as PP/PE/PP). A case for a general battery may be used as a battery case. Examples of the battery case include a battery case made of SUS.

5. Sodium Ion Battery

The sodium ion battery of the present invention is not particularly limited as long as the battery has the cathode active material layer, anode active material layer and electrolyte layer described above. In addition, the sodium ion battery of the present invention may be a primary battery or a secondary battery, preferably a secondary battery among them. The reason therefor is to be repeatedly charged and discharged and be useful as a car-mounted battery, for example. The primary battery includes an application as a primary battery (an application intended to use only for one discharge). Examples of the shape of the sodium ion battery of the present invention include a coin shape, a laminate shape, a cylindrical shape and a rectangular shape. A producing method for the sodium ion battery is not particularly limited but is the same as a producing method for a general sodium ion battery.

C. Lithium Ion Battery

FIG. 1 is a schematic cross-sectional view showing an example of a lithium ion battery of the present invention. A lithium ion battery 10 shown in FIG. 1 comprises a cathode active material layer 1, an anode active material layer 2, an electrolyte layer 3 formed between the cathode active material layer 1 and the anode active material layer 2, a cathode current collector 4 for collecting the cathode active material layer 1, an anode current collector 5 for collecting the anode active material layer 2, and a battery case 6 for storing these members. The anode active material layer 2 contains the anode active material described in the “A. Anode active material”.

According to the present invention, the use of the anode active material described above allows the lithium ion battery with high safety.

Incidentally, the lithium ion battery of the present invention is basically the same as the contents described in the “B. Sodium ion battery”; therefore, only different points are hereinafter described.

Examples of the cathode active material include bed type active materials, spinel type active material, and olivine type active materials. Examples of the cathode active material include an oxide active material. Specific examples of the cathode active material include LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, LiFePO₄, LiMnPO₄, LiNiPO₄ and LiCuPO₄.

Examples of a supporting salt (a lithium salt) used for the electrolyte layer include inorganic lithium salts such as LiPF₆, LiBF₄, LiClO₄ and LiAsF₆; and organic lithium salts such as LiCF₃SO₃, LiN(CF₃SO₂)₂, LiN(C₂F₅SO₂)₂, LiN(FSO₂)₂ and LiC(CF₃SO₂)₃.

Incidentally, the present invention is not intended to be limited to the embodiment described above. The embodiment described above is given only for illustrative purposes, and any embodiment having substantially the same configuration as the technical idea described in the claims of the present invention and provides similar operating effects, is construed to be included in the technical scope of the present invention.

### EXAMPLES

The present invention is described more specifically while showing examples hereinafter.

### Example 1

K₂CO₃, La₂O₃ and Nb₂O₅ as raw materials were weighed at a molar ratio of K₂CO₃:La₂O₃:Nb₂O₅=1:1:2, and kneaded by ball mill. Thereafter, the mixture was molded into pellets, which were burned in the air on the conditions of 1100° C. and 10 hours. Thus, an active material of KLaNb₂O₇ (A′=K, A=La, B=Nb and k=2) was obtained.

### Example 2

The active material synthesized in Example 1 was added to a nitric acid aqueous solution, and the mixture was stirred at room temperature for 24 hours to ion-exchange K ions for H ions. Next, the obtained test sample was added to a sodium hydroxide aqueous solution, and the mixture was stirred at room temperature for 48 hours to ion-exchange H ions for Na ions. Thereafter, the obtained test sample was filtered, washed in water and dried to thereby obtain an active material of NaLaNb₂O₇ (A′=Na, A=La, B=Nb and k=2).

### Example 3

K₂CO₃, CaCO₃ and Nb₂O₅ as raw materials were weighed at a molar ratio of K₂CO₃:CaCO₃:Nb₂O₅=1:2:3, and kneaded by ball mill. Thereafter, the mixture was molded into pellets, which were burned in the air on the conditions of 1100° C. and 40 hours. Thus, an active material of KCa₂Nb₃O₁₀ (A′=K, A=Ca, B=Nb and k=3) was obtained.

### Example 4

The active material synthesized in Example 3 and sodium nitrate (NaNO₃) were kneaded by ball mill. Next, the obtained test sample was burned in the air on the conditions of 340° C. and 80 hours to ion-exchange K ions for Na ions. Thereafter, the obtained test sample was filtered, washed in water and dried to thereby obtain an active material of NaCa₂Nb₃O₁₀ (A′=Na, A=Ca, B=Nb and k=3).

### Example 5

Na₂CO₃, CaCO₃ and Nb₂O₅ as raw materials were weighed at a molar ratio of Na₂CO₃:CaCO₃:Nb₂O₅=1:1:2, and Na₂SO₄ as flux was further added thereto and the mixture was kneaded by ball mill. Thereafter, the mixture was molded into pellets, which were burned in the air on the conditions of 1100° C. and 10 hours. Thereafter, the obtained test sample was filtered, washed in water and dried to thereby obtain an active material of Na[NaCa₂Nb₄O₁₃] (A′=Na, A=Na, Ca, B=Nb and k=4).

### [Evaluations]

### (X-Ray Diffraction Measurement)

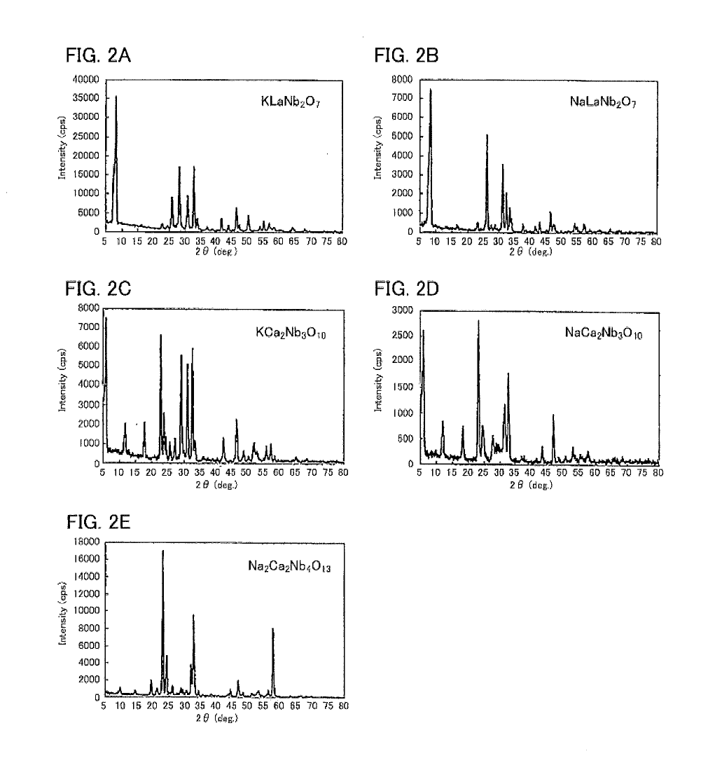

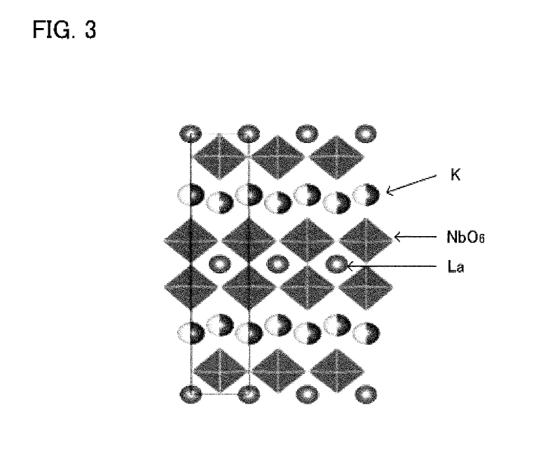

X-ray diffraction (XRD) measurement by using a CuKα ray was performed for the active materials each obtained in Examples 1 to 5. The results are shown in FIGS. 2A to 2E. As shown in FIGS. 2A to 2E, it was confirmed that the active materials obtained in any of Examples 1 to 5 contained the intended Dion-Jacobson type crystal phase as the main body. FIGS. 2A and 2B are both XRD charts in the case of k=2. In FIGS. 2A and 2B, the tendency of peak strength differs from each other whereas peak position is common. Incidentally, K ions and Na ions differ slightly in peak position by reason of differing in ionic radius. Also, FIGS. 2C and 2D are both XRD charts in the case of k=3. In FIGS. 2C and 2D, the tendency of peak strength differs from each other whereas peak position is common. Similarly, K ions and Na ions differ slightly in peak position by reason of differing in ionic radius. Also, FIG. 2E is an XRD chart in the case of k=4. Also, the crystal system and space group of the active materials obtained in Examples 1 to 5 were the KLaNb₂O₇ phase (orthorhombic crystal, Cram), the NaLaNb₂O₇ phase (orthorhombic crystal close to tetragonal crystal, I4/mmm), the KCa₂Nb₃O₁₀ phase (orthorhombic crystal, Cmcm), the NaCa₂Nb₃O₁₀ phase (orthorhombic crystal close to tetragonal crystal, P42/ncm) and the Na[NaCa₂Nb₄O₁₃] phase (orthorhombic crystal, Immm), respectively. Incidentally, FIG. 3 shows the crystal structure of KLaNb₂O₇ as an example of the Dion-Jacobson type crystal phase. As shown in FIG. 3, KLaNb₂O₇ has a layer structure in which a K layer and a perovskite layer composed of an NbO₆ octahedron and La were laminated.

### (Charge and Discharge Test)

An evaluation battery using the active materials each obtained in Examples 1 to 5 was produced. First, the obtained active material, a conductive material (acetylene black), and a binder (polyvinylidene fluoride, PVDF) were mixed and kneaded at a weight ratio of active material:conductive material:binder=85:10:5 to thereby obtain a paste. Next, the obtained paste was coated on a copper foil by a doctor blade, dried and pressed to thereby obtain a test electrode having a thickness of 20 μm.

Thereafter, a CR2032-type coin cell was used, the test electrode was used as a working electrode, metallic Na was used as a counter electrode, and a porous separator of polypropylene/polyethylene/polypropylene (a thickness of 25 μm) was used as a separator. A solution in which NaPF₆ was dissolved at a concentration of 1 mol/L in a solvent, in which EC (ethylene carbonate) and DEC (diethyl carbonate) were mixed by the same volume, was used as a liquid electrolyte.

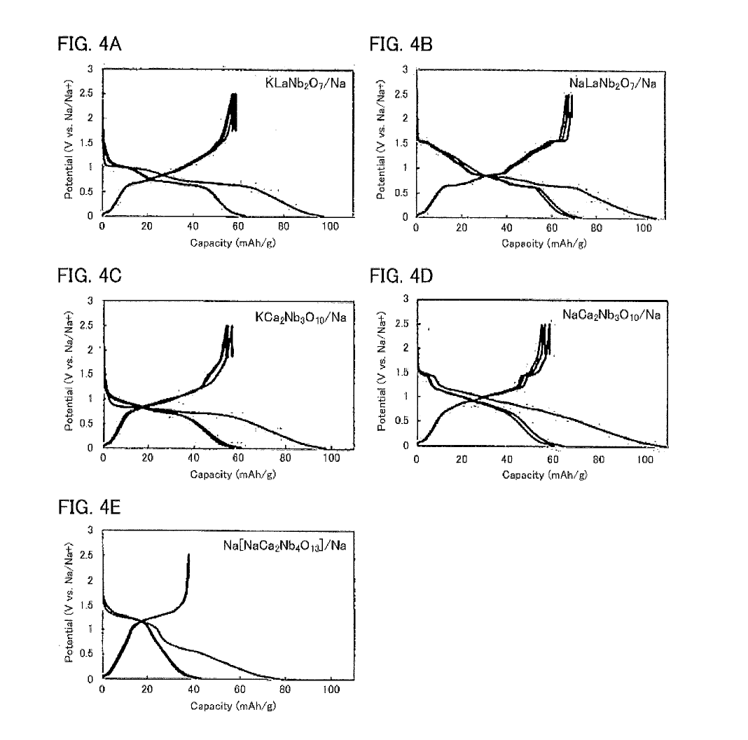

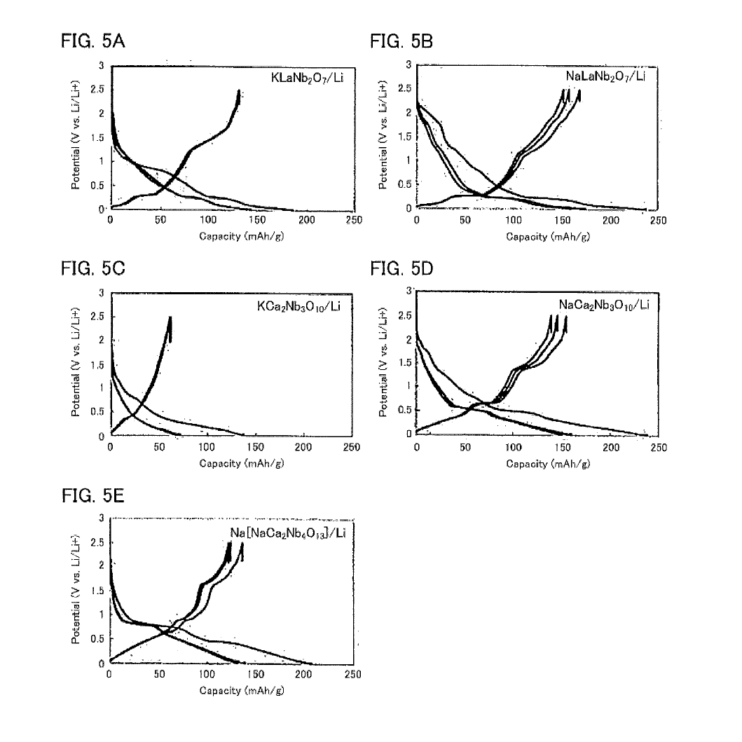

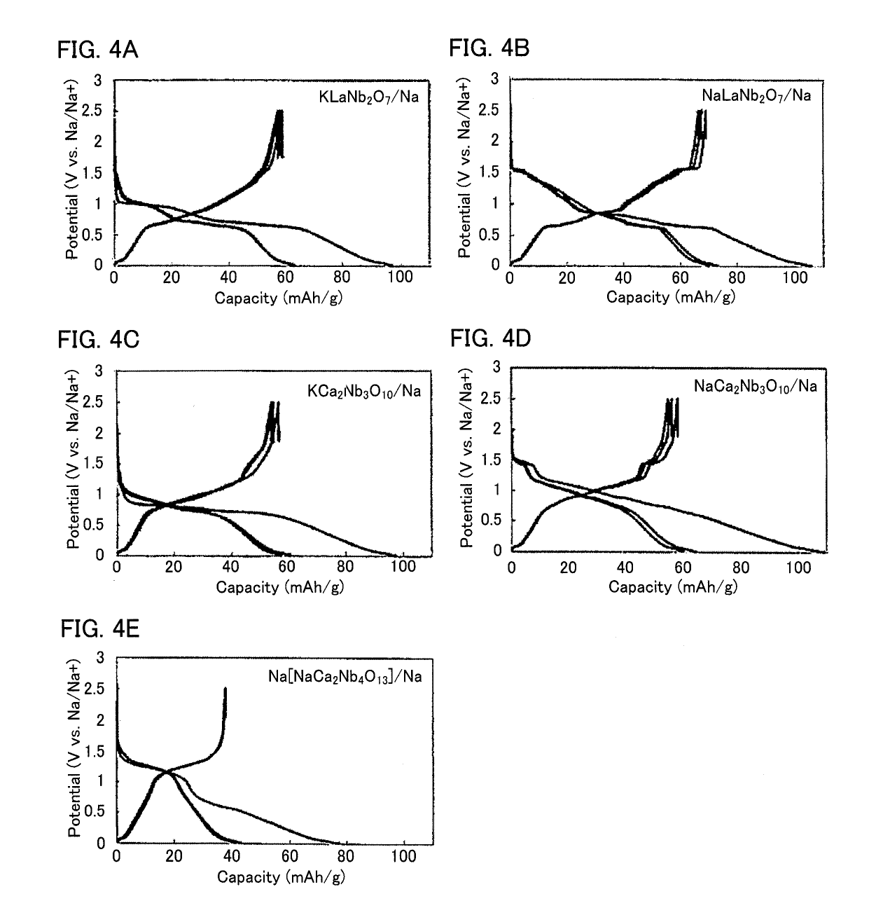

Next, a charge and discharge test was performed for the obtained evaluation battery. Specifically, the test was performed on the conditions of an environmental temperature of 25° C. and a voltage range of 10 mV to 2.5 V. The electric current value was determined at 3 mA/g. The results are shown in FIGS. 4A to 4E.

As shown in FIGS. 4A to 4E, it was confirmed that an insertion desorption reaction of Na ions was caused in the active materials obtained in any of Examples 1 to 5, which functioned as an active material. Reaction potential in accordance with the Na insertion desorption reaction in any thereof was within a range of 0.5 V (vs Na/Na⁺) to 1.5 V (vs Na/Na⁺). The active materials obtained in Examples 1 to 5 acts in the vicinity of 1 V (vs Na/Na⁺), so as to improve safety of the battery.

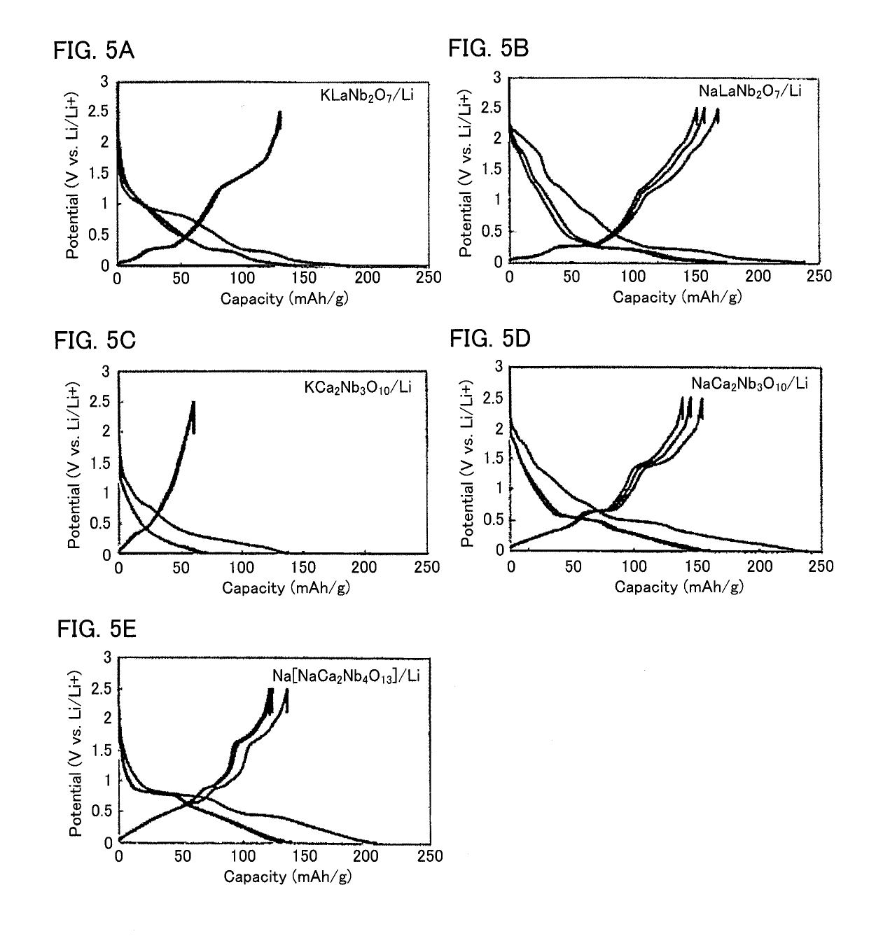

Also, an evaluation battery (supporting salt: LiPF₆=1 mol/L, solvent: EC/DMC/EMC=3/4/3) was produced in the same manner as the above by using metallic Li as a counter electrode to perform a charge and discharge test in the same manner as the above. The results are shown in FIGS. 5A to 5E.

As shown in FIGS. 5A to 5E, it was confirmed that an insertion desorption reaction of Li ions was caused in the active materials obtained in any of Examples 1 to 5, which functioned as an active material. Also, in spite of varying with kinds of the active material, any reaction potential in accordance with the Li insertion desorption reaction is so higher than the Li insertion desorption potential of hard carbon and graphite as to allow safety of the battery to be improved.

### REFERENCE SIGNS LIST

1 . . . cathode active material layer
2 . . . anode active material layer
3 . . . electrolyte layer
4 . . . cathode current collector
5 . . . anode current collector
6 . . . battery case
10 . . . sodium ion battery or lithium ion battery

What is claimed is:

1. An anode active material used for a sodium ion battery or a lithium ion battery,
wherein the anode active material has an A′Aₖ₋₁BₖO₃ₖ₊₁ phase (A′ is at least one kind of K and Na, A is at least one kind of La, Ce, Pr, Nd, Sm, Eu, Gd, Ca and Sr, B is Nb, and k is 2, 3 or 4) as a Dion-Jacobson type crystal phase.

2. The anode active material according to claim 1, wherein the A is at least one kind of La and Ca.

3. The anode active material according to claim 1, wherein a part of the A is substituted with Na.

4. A sodium ion battery comprising a cathode active material layer containing a cathode active material, an anode active material layer containing an anode active material, and an electrolyte layer formed between the cathode active material layer and the anode active material layer,
wherein the anode active material is the anode active material according to claim 1.

5. A sodium ion battery comprising a cathode active material layer containing a cathode active material, an anode active material layer containing an anode active material, and an electrolyte layer formed between the cathode active material layer and the anode active material layer,
wherein the anode active material is the anode active material according to claim 2.

6. A sodium ion battery comprising a cathode active material layer containing a cathode active material, an anode active material layer containing an anode active material, and an electrolyte layer formed between the cathode active material layer and the anode active material layer,
wherein the anode active material is the anode active material according to claim 3.

7. A lithium ion battery comprising a cathode active material layer containing a cathode active material, an anode active material layer containing an anode active material, and an electrolyte layer formed between the cathode active material layer and the anode active material layer,
wherein the anode active material is the anode active material according to claim 1.

8. A lithium ion battery comprising a cathode active material layer containing a cathode active material, an anode active material layer containing an anode active material, and an electrolyte layer formed between the cathode active material layer and the anode active material layer,
wherein the anode active material is the anode active material according to claim 2.

9. A lithium ion battery comprising a cathode active material layer containing a cathode active material, an anode active material layer containing an anode active material, and an electrolyte layer formed between the cathode active material layer and the anode active material layer,
wherein the anode active material is the anode active material according to claim 3.
